(19) United States
(12) Patent Application Publication
(10) Pub. No.: US 2013/0198791 A1
(43) Pub. Date: Aug. 1, 2013

(54) E-BOOK-BASED ON-LINE BROADCASTING STUDY SYSTEM AND METHOD

(71) Applicants: Jong-Hyeon YUN, Cheongju (KR); Seok-Jae Lee, Daejeon (KR); Seok-Bin Kang, Daejeon (KR); Jae-Sang Yoo, Daejeon (KR); Su-Woong Lee, Daejeon (KR); Jun-Suk Lee, Daejeon (KR)

(72) Inventors: Jong-Hyeon YUN, Cheongju (KR); Seok-Jae Lee, Daejeon (KR); Seok-Bin Kang, Daejeon (KR); Jae-Sang Yoo, Daejeon (KR); Su-Woong Lee, Daejeon (KR); Jun-Suk Lee, Daejeon (KR)

(73) Assignee: Electronics and Telecommunications Research Institute, Daejeon (KR)

(21) Appl. No.: 13/548,153

(22) Filed: Jul. 12, 2012

(30) Foreign Application Priority Data
Jan. 31, 2012 (KR) 10-2012-0010013

(51) Int. Cl. H04N 21/643; H04N 21/858; H04N 21/236

(52) U.S. Cl. 725/112; 725/109

(57) ABSTRACT

Provided is an on-line broadcasting study system and method that provides e-book content of a mobile terminal and educational broadcasting content of a smart TV in an associated manner. The mobile terminal processes and outputs e-book content including association information indicating association with specific broadcasting content received from an educational content server, and transmits a broadcasting content transmission request selected according to a user input signal for selecting broadcasting content associated with e-book content, to the smart TV. The smart TV transmits the broadcasting content transmission request of the mobile terminal to a broadcasting content server, and receives and outputs broadcasting content searched for and acquired by the broadcasting content server by using the association information according to the broadcasting content transmission request.

### CROSS-REFERENCE TO RELATED APPLICATION

This application claims the benefit under 35 U.S.C. §119(a) of Korean Patent Application No. 10-2012-0010013, filed on Jan. 31, 2012, the entire disclosure of which is incorporated herein by reference for all purposes.

### BACKGROUND

1. Field

The following description relates to an e-book-based on-line broadcasting study system, and more particularly, to technology for providing e-book content of a mobile terminal and broadcasting content of a smart television (TV) in an associated manner.

2. Description of the Related Art

E-learning performed in educational broadcasting system, Internet educational broadcasting, or the like provides a video-on-demand (VOD)-based educational broadcasting service associated with off-line educational broadcasting material. However, since current on-line educational broadcasting provides off-line learning material and on-line broadcasting content separately, it is not easy to provide service connecting the off-line learning material and on-line broadcasting content. Also, with conventional on-line educational broadcasting services, a learner has no choice but to receive all broadcast content, and since this inevitably includes unneeded content, learning efficiency is lowered.

However, recently, due to the widespread popularization of tablet personal computers (PCs) and pad-type mobile wireless terminals, off-line educational content such as textbooks are becoming available as on-line e-book content. Also, due to the popularization of smart TVs, it is becoming possible to share and control multimedia content between various screens such as mobile wireless terminals, PCs, TVs, and the like, which makes an N-screen content providing service possible.

### SUMMARY

The following description relates to an on-line broadcasting study system and method that provide e-book content of a mobile terminal and educational broadcasting content of a smart TV in an associated manner.

In one general aspect, a smart TV includes: a communication unit configured to communicate with a mobile terminal, an educational content server providing e-book content including association information indicating association with specific broadcasting content, and a broadcasting content server providing broadcasting content; an application executing unit configured to receive a broadcasting content transmission request for broadcasting content is associated with e-book content from the mobile terminal, transmit the broadcasting content transmission request to the broadcasting content server, receive broadcasting content searched for and acquired by the broadcasting content server from the broadcasting content server by using the association information, and reproduce the received broadcasting content; and an output unit configured to output the broadcasting content.

In another aspect, a method of providing an on-line learning service by using a mobile terminal and a smart TV includes: processing and outputting, by the mobile terminal, e-book content including association information indicating association with specific broadcasting content received from an educational content server; transmitting, by the mobile terminal, a broadcasting content transmission request selected according to a user input signal for selecting broadcasting content associated with e-book content, to the smart TV; transmitting, by the smart TV, the broadcasting content transmission request of the mobile terminal to a broadcasting content server; and receiving and outputting, by the smart TV, broadcasting content searched for and acquired by the broadcasting content server by using the association information according to the broadcasting content transmission request.

Other features and aspects will be apparent from the following detailed description, the drawings, and the claims.

### BRIEF DESCRIPTION OF THE DRAWINGS

FIG. 1 is a diagram illustrating a configuration of an e-book-based on-line broadcasting study system according to an exemplary embodiment of the present invention.

FIG. 2 is a diagram illustrating an example of a configuration of a broadcasting content server included in the on-line broadcasting study system of FIG. 1.

FIG. 3 is a diagram illustrating an example of a configuration of an educational content is server included in the on-line broadcasting study system of FIG. 1.

FIG. 4 is a diagram illustrating an example of a configuration of a mobile terminal included in the on-line broadcasting study system of FIG. 1.

FIG. 5 is a diagram illustrating an example of a configuration of a smart TV included in the on-line broadcasting study system of FIG. 1.

FIG. 6 is a diagram illustrating a process of providing e-book content associated with broadcasting content to a mobile terminal, and providing broadcasting content associated with e-book content to a smart TV, according to an exemplary embodiment of the present invention.

FIG. 7 is a diagram illustrating a process of providing e-book content associated with broadcasting content to a mobile terminal, and providing broadcasting content associated with e-book content to a smart TV, according to another exemplary embodiment of the present invention.

FIG. 8 is a diagram illustrating a service flow of providing broadcasting content associated with sub-content of e-book content, according to an exemplary embodiment of the present invention.

FIG. 9 is a diagram illustrating a service flow of analyzing the result of a learning input such as problem solving and then providing broadcasting content associated therewith.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive is understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, exemplary embodiments of the invention will be described with reference to the accompanying drawings. Detailed descriptions of well-known functions and configurations may be omitted in favor of greater focus on the subject matter of the present invention. Some of the terms used herein have been chosen to reflect functions performed by components of the present invention. As these functions may vary depending on the intentions and practices of users or operators, the terms used herein should be understood within the context of the description and not in an overly rigid or formal sense.

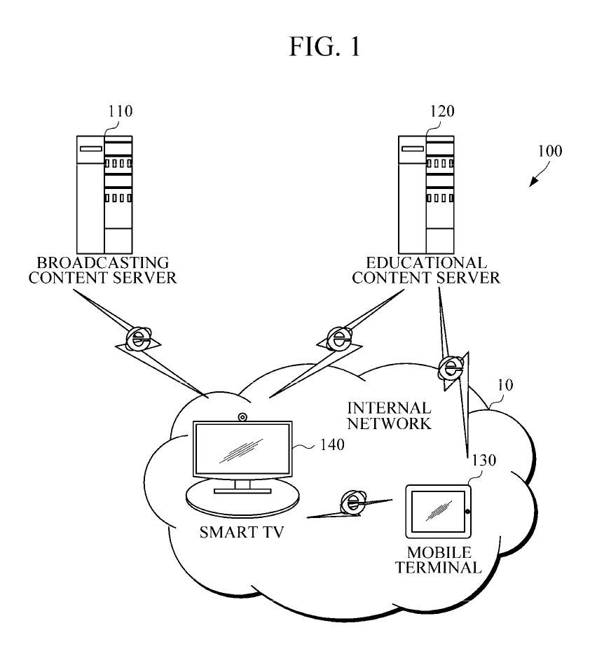

FIG. 1 is a diagram illustrating a configuration of an e-book-based on-line broadcasting study system according to an exemplary embodiment of the present invention.

Referring to FIG. 1, an on-line broadcasting study system 100 may include a broadcasting content server 110, an educational content server 120, a mobile terminal 130, and a smart TV 140.

Inter-screen refers to a system for linking various types of terminals that makes it possible to achieve learning objectives by performing customized learning operations in various types of terminals based on learner information. The on-line broadcasting study system 100 may provide learners with broadcasting content, supplementary broadcasting content, e-book content, and supplementary e-book content through an inter-screen system.

Broadcasting content refers to VOD-based audio and video content. The broadcasting content may be referred to as VOD content. The broadcasting content may be managed in is association with e-book content.

The supplementary broadcasting content is additional information that may be provided in relation to the broadcasting content. The supplementary broadcasting content may include captions, text such as study notes, images, or summary information of additional content. The summary information of additional content may include description information of other content associated with the broadcasting content, and a URL of the associated other content. The associated other content may be other broadcasting content, or various types of content such as text and images. If there is a plurality of associated content, the summary information of additional content may include a URL list of the associated content. The supplementary broadcasting content may be managed in association with the respective broadcasting content.

E-book content refers to content associated with the broadcasting content and can be output through an e-book viewer installed in the mobile terminal 130. The e-book content may include association information indicating association with specific broadcasting content. One unit of e-book content may include a plurality of units of sub-content. The plurality of units of sub-content may be selected according to a user input signal.

The sub-content may correspond to text, images, icons, or the like that are included in a specific page or an e-book, or in a partial region of the specific page. One unit of e-book content may be associated with one unit of broadcasting content, and the units of sub-content constituting one unit of e-book content may be associated with different broadcasting content. Sub-content association information such as a URL indicating a location of associated broadcasting content may be included in each unit of sub-content, so that each unit of sub-content may be associated with corresponding broadcasting content.

The supplementary e-book content is additional information that may be provided together with the e-book content. The supplementary e-book content may be output through an is e-book viewer installed in the mobile terminal 130. The supplementary e-book content may include various types of content such as text, images, audio, and video.

The on-line broadcasting study system 100 associates the e-book viewer of the mobile terminal 130 with the smart TV 140 and provides broadcasting content associated with e-book content to a learner through the smart TV 140. Also, the on-line broadcasting study system 100 provides e-book content associated with broadcasting content provided to the smart TV 140 to the learner through the e-book viewer of the mobile terminal 120, thus providing an inter-screen-based on-line broadcasting learning environment. Also, the on-line broadcasting study system 100 provides a more convenient on-line broadcasting learning service to the learner by enabling the learner to directly control the broadcasting content of the smart TV 140 through the e-book viewer of the mobile terminal 130. For example, the mobile terminal 130 may provide control of broadcasting content reproduced through the smart TV 140 (for example, broadcasting pause, broadcasting reproduction, and reproduction speed control) and interaction necessary for learning (for example, answer input and answer submission).

The broadcasting content server 110 transmits and manages broadcasting content associated with e-book content, and supplementary broadcasting content.

The educational content server 120 transmits and manages e-book content associated with broadcasting content, and supplementary e-book content.

The mobile terminal 130 has a display screen that may communicate with the smart TV 140 of an internal network 10 and the external educational content server 120 by using one of various communication protocols such as Bluetooth, Wireless USB, Infrared Ray Communication, RFID, Zigbee, UWB, and Wireless LAN. The mobile terminal 130 is loaded with a program such as an e-book viewer that can output broadcasting-associated e-book content stored in the educational content server 120.

The smart TV 140 may communicate with the mobile terminal 130 of the internal network 10, the external broadcasting content server 110, and the educational content server 120 by using one of various communication protocols such as Bluetooth, Wireless USB, Infrared Ray Communication, RFID, Zigbee, UWB, and Wireless LAN. The smart TV 140 is loaded with a program that can request broadcasting content and e-book content requested by the mobile terminal 130, from the broadcasting content server 110 and the educational content server 120, and can receive and process requested broadcasting content and e-book content.

According to an exemplary embodiment, a user of the mobile terminal 130 and the smart TV 140 may be a learner that uses on-line broadcasting learning. The user may receive e-book content through the mobile terminal 130. Also, while receiving e-book content through the mobile terminal 130, the user may receive broadcasting content associated with e-book content provided through the mobile terminal 130, through the smart TV 140. Also, the user may receive broadcasting content associated with a sub-content selected according to the selection of specific sub-content of e-book content provided through the mobile terminal 130, through the smart TV 140.

The e-book content associated with broadcasting content received by the mobile terminal 130 may include a plurality of units of sub-content. The user may select specific sub-content among the provided sub-content, and request and reproduce specific broadcasting content associated with the selected sub-content among the e-book content, from the broadcasting content server 110 through the smart TV 140. The sub-content may include sub-content association information indicating broadcasting content associated with each unit of sub-content. The sub-content association information may be a broadcasting content URL that indicates a storage position of broadcasting content and is used by the broadcasting content server 110 to search for broadcasting content associated with e-book content.

Also, if the sub-content is question content that is configured to input an answer to a question for learning evaluation, it is assumed that a test question scoring result of e-book content is provided through the mobile terminal 130, and the test question scoring result includes an O icon indicating a correct answer to a test question and an X icon indicating an incorrect answer to a test question. In this case, when the X icon is clicked, the mobile terminal 130 may request broadcasting content associated with a test question corresponding to the X icon, from the broadcasting content server 110 through the smart TV 140, and reproduce the same through the smart TV 140.

According to the present invention, simultaneous association of off-line learning material and on-line educational broadcasting content, which was impossible in a conventional on-line educational broadcasting service, is possible, and reduction of a learning time and support of various learning services, such as learning evaluation and problem solving, are possible. Also, an inter-screen-based service capable of controlling broadcasting content provided through the smart TV 140, by the e-book viewer of the mobile terminal 130, is possible.

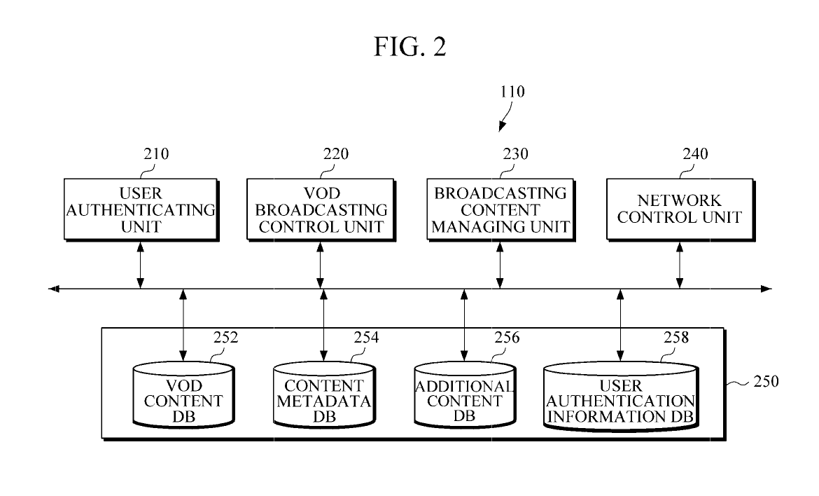

FIG. 2 is a diagram illustrating an example of a configuration of the broadcasting content server 110 included in the on-line broadcasting study system 100 of FIG. 1.

Referring to FIG. 2, the broadcasting content server 110 may include a user authenticating unit 210, a VOD broadcasting control unit 220, a broadcasting content managing unit 230, a network control unit 240, and a database (DB) 250.

The user authenticating unit 210 performs user authentication to check the use authority of a user that has accessed the broadcasting content server 110.

The VOD broadcasting control unit 220 controls execution of VOD content according to a control signal according to a user request.

The broadcasting content managing unit 230 searches and manages VOD broadcasting is content, content metadata, and supplementary broadcasting content stored in the broadcasting content DB 250.

The network control unit 240 manages a network connection with the smart TV 140. The database 250 may include a VOD content DB 252, a content metadata DB 254, additional content DB 256, and a user authentication information DB 258.

The VOD content DB 252 may store broadcasting content for VOD-based broadcasting learning. The content metadata DB 254 may store content metadata for describing broadcasting content. The additional content DB 256 may store additional content such as captions supplementing broadcasting content, text such as study notes, images, and a separate associated broadcasting video content URL.

The user authentication information DB may manage user authentication information that is used by the user authenticating unit 210 in a user authenticating process.

When receiving a broadcasting content transmission request for transmission of broadcasting content associated with e-book content from the smart TV 140, the broadcasting content managing unit 230 may search for broadcasting content in the VOD content DB 252 by using association information included in the broadcasting content transmission request (for example, a URL of associated broadcasting content), search for additional content associated with the searched broadcasting content from the additional content DB 256, and transmit the searched broadcasting content to the smart TV 140. The broadcasting content managing unit 230 may also transmit additional content associated with the searched broadcasting content to the smart TV 140.

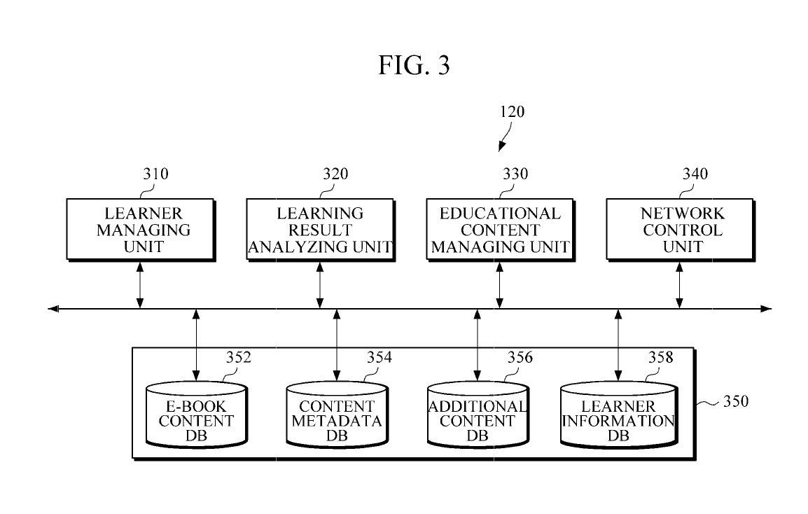

FIG. 3 is a diagram illustrating an example of a configuration of the educational content server 120 included in the on-line broadcasting study system 100 of FIG. 1.

Referring to FIG. 3, the educational content server 120 may include a learner managing is unit 310, a learning result analyzing unit 320, an educational content managing unit 330, a network control unit 340, and a database (DB) 350.

The learner managing unit 310 may manage users using the educational content server 120 and learning history information of the users.

The learning result analyzing unit 320 analyzes a learning input that is input by a user through the educational content server 120 (for example, an input answer to a question for learning evaluation).

The educational content managing unit 330 may search and manage e-book content, content metadata, and additional content of the e-book content, which is stored in the database 350.

The network control unit 340 may manage a network connection with the mobile terminal 130 and the smart TV 140 used by the user.

The database 350 may include e-book content DB 352, a content metadata DB 354, additional content DB 356, and a learner information DB 358.

The e-book content DB 352 may store e-book content including e-book content associated with broadcasting content that may be output through the e-book content viewer of the mobile terminal 130.

The content metadata DB 354 may store content metadata for describing e-book content.

The additional content DB 356 may store additional content including text, images, audio, and video, which may be provided to supplement e-book content and may be output through the e-book content viewer.

The learner information database 358 may store learning history and authentication information about users using the educational content server 120.

The broadcasting content server 110 and the educational content server 120 may share is authentication information about users. Authentication information of a user subscribing to the educational content server 120 may be transmitted to the user authentication unit 210 of the broadcasting content server 110, and the user authenticating unit 210 of the broadcasting content server 110 may provide broadcasting content to an authenticated user without a separate authentication process. Accordingly, the user may use a service of the on-line broadcasting study system 100 by subscribing to only the educational content server 120.

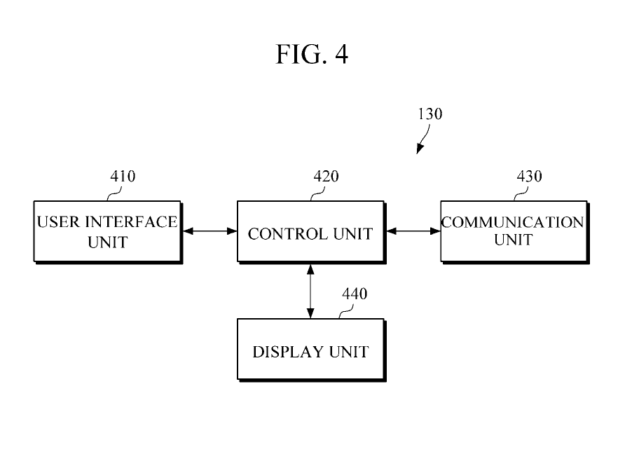

FIG. 4 is a diagram illustrating an example of a configuration of the mobile terminal 130 included in the on-line broadcasting study system 100 of FIG. 1.

Referring to FIG. 4, the mobile terminal 130 may include a user interface unit 410, a control unit 420, a communication unit 430, and a display unit 440.

The user interface unit 410 may receive a user input signal and transmit the same to the control unit 420.

The control unit 420 may execute an application for operating the mobile terminal 130. The control unit 420 may execute a broadcasting learning program for providing e-book content associated with broadcasting content. The broadcasting learning program may include an e-book content viewer capable of outputting e-book content including e-book content associated with broadcasting content, a learning input supporting program for creating an answer to e-book content for a problem related to e-book content or supporting creation of a memo, a note, or the like, and a broadcasting learning control program for controlling output of broadcasting content of the smart TV 140 through the mobile terminal 130.

The control unit 420 may perform synchronization of the mobile terminal 130 for providing a broadcasting service environment. The control unit 420 may receive e-book content including association information about broadcasting content from the educational content server 120, and generate a screen for allowing the user to select broadcasting content is associated with e-book content.

The communication unit 430 may communicate with the broadcasting content server 110, the educational content server 120, and the smart TV 140 according to a network control signal for managing a network connection of the control unit 420.

The display unit 440 may display an execution screen of a broadcasting learning program executed by the control unit 420. For example, the display unit 330 may display e-book content processed through the e-book content viewer.

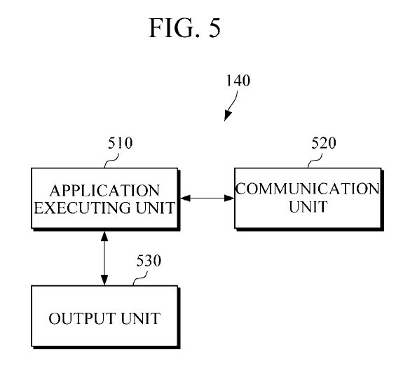

FIG. 5 is a diagram illustrating an example of a configuration of the smart TV 140 included in the on-line broadcasting study system 100 of FIG. 1.

Referring to FIG. 5, the smart TV 140 may include an application executing unit 510, a communication unit 520, and an output unit 530.

The application executing unit 510 may execute various applications for controlling overall operation of the smart TV 140. Also, the application executing unit 510 may perform synchronization with the mobile terminal 130 for providing a broadcasting service environment.

The application executing unit 510 may execute a broadcasting learning program for providing and controlling broadcasting content. By execution of the broadcasting learning program, the application executing unit 510 may provide a broadcasting content viewer for outputting and controlling VOD broadcasting content of the broadcasting content server 110.

When receiving a learning control signal for controlling broadcasting content in relation to learning from the mobile terminal 130, the application executing unit 510 may support an input of the learning control signal, analyze an operation command included in the learning control signal, and request processing of the operation command to the broadcasting content server 110 or the educational content server 120 through the communication unit 520. A is separate user input interface may be included in the smart TV 140, and the application executing unit 510 may process a learning control signal input through the user input interface.

When receiving an e-book content transmission request for transmission of e-book content associated with broadcasting content from the mobile terminal 130, the application executing unit 510 may transmit the e-book content transmission request to the educational content server 120, receive e-book content from the educational content server 120 through the communication unit 520, and transmit the received e-book content to the mobile terminal 130.

When receiving summary information about additional content of broadcasting content from the broadcasting content server 110 together with the broadcasting content, the application executing unit 510 may transmit the summary information about the additional content to the mobile terminal 130 through the communication unit 520.

As described above, the sub-content included in the e-book content may include question content for learning evaluation. When the mobile terminal 130 displays question content, receives answer information about the question content from the user, and receives question identification information about the question content and answer information about each question from the mobile terminal 130, the application execution unit 510 may transmit the question identification information and an evaluation analysis of a question including the answer information about each question to the educational content server 120. When receiving an additional content URL related to identification information about each question from the educational content server 120 through the communication unit 520, the application executing unit 510 may transmit the additional content URL related to identification information about each question to the mobile terminal 130.

The communication unit 520 may manage a network connection with the broadcasting is content server 110 and the educational content server 120. Also, the communication unit 520 may transmit a learning control signal input from the mobile terminal 130 to the application executing unit 510.

The output unit 530 may output an execution screen of a broadcasting learning program of the application executing unit 510. For example, the output unit 520 may output broadcasting content processed by the broadcasting content viewer.

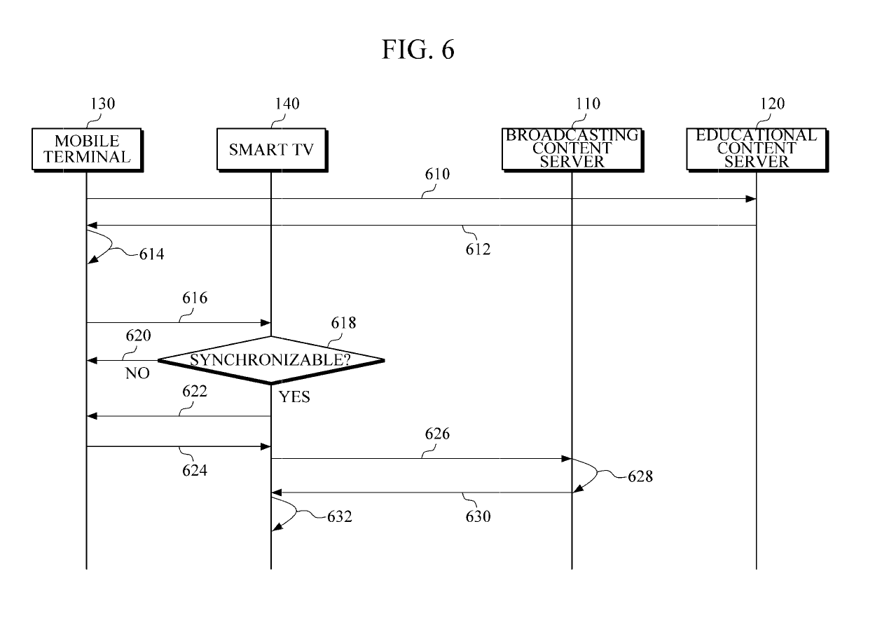

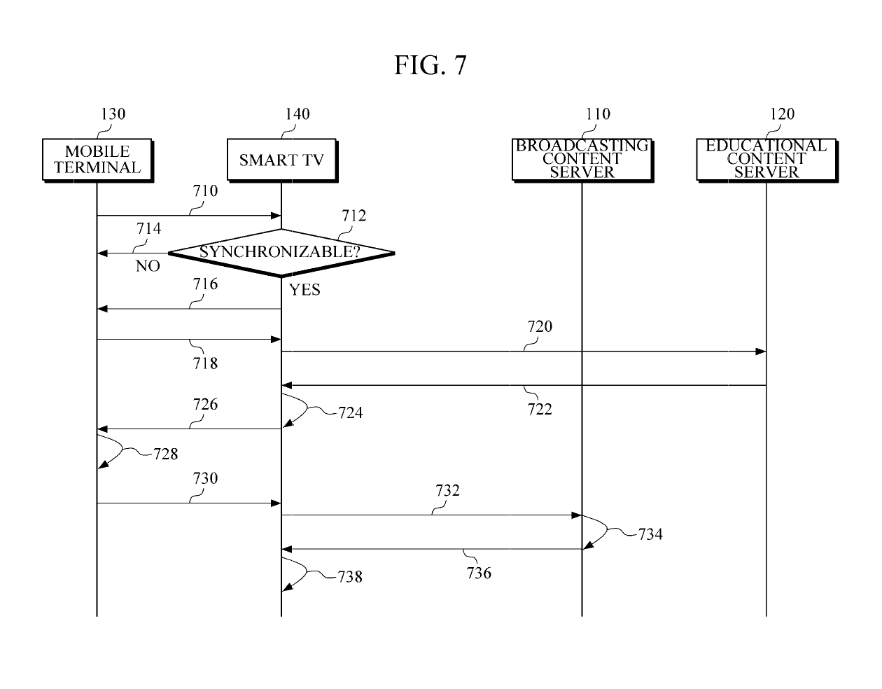

Before receiving broadcasting content, the user may receive e-book content from the educational content server 120 and store the same in the mobile terminal 130. When the e-book content is stored in the mobile terminal 130, the user may communicate with the smart TV 140, request broadcasting content associated with the e-book content from the broadcasting content server 110, and reproduce the same through the smart TV 140. This service may be provided through a service scenario of FIGS. 6 and 7.

FIG. 6 is a diagram illustrating a process of providing e-book content associated with broadcasting content to the mobile terminal 130, and providing broadcasting content associated with e-book content to the smart TV 140, according to an exemplary embodiment of the present invention.

Referring to FIG. 6, the mobile terminal 130 may access the educational content server 120 to request e-book content associated with broadcasting content (610), and may receive the e-book content (612) and store the e-book content (614).

After completion of the storage of the e-book content, the mobile terminal 130 may communicate with the smart TV 140 and perform a synchronization operation that allows a learning program of the mobile terminal 130 and a learning program of the smart TV 140 to provide an on-line learning broadcasting service. To this end, the mobile terminal 130 may transmit a service environment synchronization request to the smart TV 140 (616), and the smart is TV 140 may analyze the service environment synchronization request to determine whether the mobile terminal is synchronizable (618). If the mobile terminal 130 is not synchronizable, the smart TV 140 may transmit a synchronization failure message (620); and if the mobile terminal 130 is synchronizable, the smart TV 140 may transmit a synchronization success message (622).

When receiving the synchronization success message and completing the synchronization operation, the mobile terminal 130 may transmit a broadcasting content request to the smart TV 140 so that broadcasting content associated with e-book content may be output through the learning program to the smart TV 140 (624). The smart TV 140 may transmit the broadcasting content request to the broadcasting content server 110 (626). The broadcasting content server 110 may search for broadcasting content corresponding to the broadcasting content request, and transmit the searched broadcasting content to the smart TV 140 (628). The smart TV 140 may receive the requested broadcasting content from the broadcasting content server 110 (630) and process and output the received broadcasting content (632).

FIG. 7 is a diagram illustrating a process of providing e-book content associated with broadcasting content to the mobile terminal 130, and providing broadcasting content associated with e-book content to the smart TV 140, according to another exemplary embodiment of the present invention.

Referring to FIG. 7, the mobile terminal 130 may transmit a service environment synchronization request to the smart TV 140 (710), and the smart TV 140 may analyze the service environment synchronization request to determine whether the mobile terminal is synchronizable (712). If the mobile terminal 130 is not synchronizable, the smart TV 140 may transmit a synchronization failure message (714); and if the mobile terminal 130 is synchronizable, the smart TV 140 may transmit a synchronization success message (716).

After successful completion of the synchronization process, the mobile terminal 130 may is transmit an e-book content request for e-book content from the educational content server 120 to the smart TV 140 (718). The e-book content requested through the e-book content request may be selected according to a user input of the mobile terminal 130, and may be content associated with specific broadcasting content. The e-book content request may include e-book content identification information and an IP address of the smart TV 140 that will receive the e-book content. In an initial operation of the mobile terminal 130, the e-book content identification information included in the e-book content request may be preset.

The smart TV 140 may transmit the e-book content request to the educational content server 120 (720) and receive the e-book content from the educational content server 120 (722).

The smart TV 140 may store the e-book content (724) and transmit the e-book content to the mobile terminal 130 (726). The mobile terminal 130 may store and execute the e-book content (728). The mobile terminal 130 may transmit a broadcasting content request for the output of broadcasting content associated with the e-book content from the smart TV, to the smart TV 140 according to a user input signal (730). The smart TV 140 may transmit the broadcasting content request to the broadcasting content server 110 (732). The broadcasting content server 110 may search for the requested broadcasting content (734), and the smart TV 140 may receive the broadcasting content (736) and process and output the received broadcasting content (738).

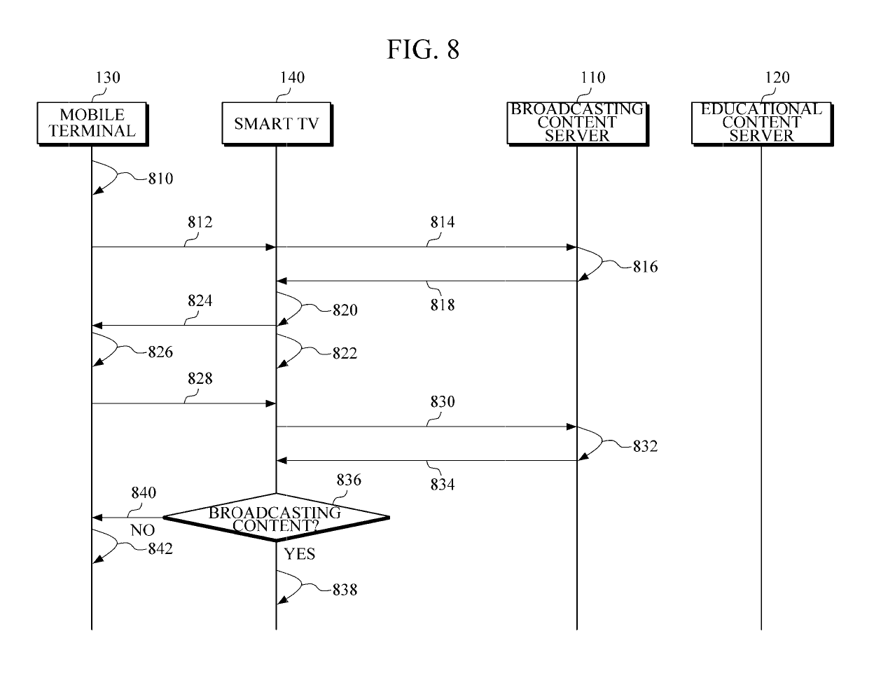

FIG. 8 is a diagram illustrating a service flow of providing broadcasting content associated with sub-content of e-book content, according to an exemplary embodiment of the present invention.

Referring to FIG. 8, when the user clicks and selects specific sub-content associated with broadcasting content from e-book content output by the mobile terminal 130 (for example, a is specific region of a screen) (810), the mobile terminal 130 may transmit a broadcasting content transmission request including sub-content association information mapped to the relevant sub-content (for example, a URL of the broadcasting content) to the smart TV 140 (812). The broadcasting content transmission request allows the smart TV 140 to receive and reproduce the requested broadcasting content.

The smart TV 140 may transmit the broadcasting content transmission request to the broadcasting content server 110 and request broadcasting content with a relevant URL (814). The broadcasting content server 110 may search for broadcasting content with the relevant URL (816) and transmit the searched broadcasting content to the smart TV 140 (818).

If there is additional content information related to the searched broadcasting content, the broadcasting content server 110 may also transmit additional content summary information for accessing additional content to the smart TV 140 (818).

The smart TV 140 may store the received broadcasting content and summary information about the additional content (820) and output the received broadcasting content (822). When receiving the summary information about the additional content together with the broadcasting content, the smart TV 140 may transmit the summary information about the additional content to the mobile terminal 130 (824). Also, the mobile terminal 130 may output the summary information about the additional content (826).

When the user uses the summary information about the additional content to make an additional content transmission request for transmission of specific additional content (828), the mobile terminal 130 may transmit the additional content transmission request to the broadcasting content server 110 (830). The additional content transmission request may include a URL of the additional content.

The broadcasting content server 110 may search for requested broadcasting content by using the additional content URL (832) and transmit the searched additional content to the smart TV 140 (834).

The smart TV 140 may receive additional content of broadcasting content that is currently reproduced by the broadcasting content server 110 from the broadcasting content server 110 (834). When the received additional content is broadcasting content such as VOD content (836), the smart TV 140 may reproduce broadcasting video content (838).

When the received additional content is content other than broadcasting video content (836), the smart TV 140 may transmit the additional content to the mobile terminal 130 (840). The mobile terminal may process and output the received additional content (842).

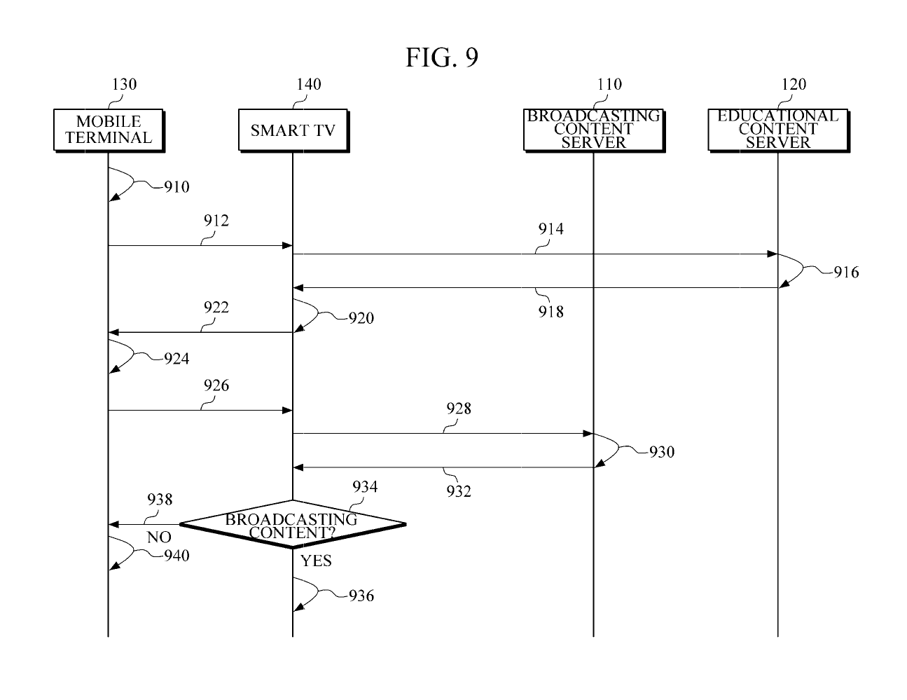

FIG. 9 is a diagram illustrating a service flow of analyzing the result of a learning input such as problem solving and then providing broadcasting content associated therewith.

Referring to FIG. 9, when e-book content is sub-content such as question content for learning evaluation, to which a learner can input an answer, content related to a question may be provided as illustrated in FIG. 9.

First, the user solves questions included in e-book content, and then inputs an answer to each question in the e-book content viewer through a learning input (910). When receiving an input of an answer to each question, a learning program of the mobile terminal 130 transmits an evaluation analysis request about the relevant answer to a learning program of the smart TV 140 (912). The evaluation analysis request is to request determination as to whether an answer to each question is correct. The evaluation analysis request may include question identification information about each question and an answer to each question, which is input by the user.

The learning program of the smart TV 140 may transmit question identification information and an answer corresponding to a learning input to the relevant question to the is educational content server 120 and request analysis of the learning result (914). The educational content server 120 may determine whether an answer to the relevant question is correct, based on the question identification information and the learning input (answer) transmitted from the smart TV 140 (916).

The educational content server 120 may determine supplementary broadcasting content to be provided to the user, among the broadcasting content mapped to each question, according to the correctness/incorrectness determination result, and search for and acquire a relevant supplementary broadcasting content URL and transmit the acquired supplementary broadcasting content URL and correctness/incorrectness information to the smart TV 140 (918). As described above, the additional content of the broadcasting content may be other broadcasting content, and may be various types of content such as images and text.

The smart TV 140 may store the correctness/incorrectness information and the additional content URL information (920), and may transmit the correctness/incorrectness information and the broadcasting content URL information to the learning program of the mobile terminal 130 (922). The mobile terminal 130 may output the received information through the e-book content viewer (924).

When the user selects a correctness/incorrectness icon (O, X) of the output question, the mobile terminal may transmit an additional content request mapped to a relevant question to the smart TV 140 (926). The smart TV 140 may transmit the additional content request mapped to the relevant question to the broadcasting content server 110 (928). The additional content request may include an additional content URL mapped to an icon selected by the user. The broadcasting content server 110 may interpret the additional content request and search for requested additional content by using the additional content URL included in the additional is content request (930), and transmit the search result to the smart TV 140 (932).

If the received additional content is broadcasting content such as VOD content (934), the smart TV 140 may output the received broadcasting content (936). On the other hand, if the received additional content is a different type of additional content (934), the smart TV 140 may transmit additional content of the broadcasting content to the mobile terminal 130 (938). The mobile terminal 130 may output the received additional content (940).

According to the configuration of the present invention described above, in an on-line educational broadcasting service, a learner may use a personal mobile terminal to receive e-book content associated with an educational broadcasting service. The personal mobile terminal may communicate with a smart TV to request reproduction of broadcasting content associated with e-book content. Broadcasting content associated with specific content of the e-book content may be selectively reproduced through the smart TV according to learner selection, and specific additional content may also be provided through a screen of the smart TV or the personal mobile terminal according to learner selection.

Accordingly, simultaneous association of off-line learning material and on-line educational broadcasting content, which was impossible in a conventional on-line educational broadcasting service, is possible, and support of various learning services, such as learning evaluation and problem solving, is possible. Also, since only content selected by a learner is provided, an unnecessary learning time, which is a drawback of the conventional educational broadcasting service, can be minimized. Accordingly, a high learning effect can be achieved within a short period of time. Since content control between the mobile terminal and the smart TV (for example, broadcasting pause and broadcasting reproduction) and interaction necessary for learning (for example, answer input and answer submission) are provided, an environment enabling the learner to use the on-line educational broadcasting service more conveniently can be is provided.

The present invention may be embodied as computer-readable codes on a computer-readable recording medium. Codes and code segments for accomplishing the present invention may be easily construed by programmers skilled in the art to which the present invention pertains. The computer-readable recording medium may be any data storage device that can store data which can be thereafter read by a computer system. Examples of the computer-readable recording medium may include read-only memory (ROM), random-access memory (RAM), CD-ROMs, magnetic tapes, floppy disks, and optical data storages. The computer-readable recording medium may also be distributed over a network of coupled computer systems so that the computer-readable code may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A smart television (TV) comprising:
a communication unit configured to communicate with a mobile terminal, an educational content server providing e-book content including association information indicating association with specific broadcasting content, and a broadcasting content server providing broadcasting content;
an application executing unit configured to receive a broadcasting content transmission request for broadcasting content associated with e-book content from the mobile terminal, transmit the broadcasting content transmission request to the broadcasting content server, receive broadcasting content searched for and acquired by the broadcasting content server from the broadcasting content server by using the association information, and reproduce the received broadcasting content; and
an output unit configured to output the broadcasting content.

2. The smart TV of claim 1, wherein the application executing unit performs synchronization with the mobile terminal to provide an on-line learning broadcasting service environment.

3. The smart TV of claim 1, wherein the application executing unit receives e-book content transmission request for transmission of e-book content from the mobile terminal, transmits the e-book content transmission request to the educational content server, receives the e-book content from the educational content server through the communication unit, and transmits the received e-book content to the mobile terminal.

4. The smart TV of claim 1, wherein the association information is a broadcasting content URL that is used by the broadcasting content server to search for broadcasting content associated with the e-book content.

5. The smart TV of claim 1, wherein the e-book content includes one or more units of sub-content, and each unit of sub-content includes sub-content association information indicating broadcasting content associated with each unit of sub-content.

6. The smart TV of claim 5, wherein the sub-content is included in a partial region of a specific page of the e-book, and is text, an image, or an icon that is selectable by a user input signal.

7. The smart TV of claim 1, wherein when receiving summary information about is additional content of broadcasting content from the broadcasting content server together with the broadcasting content, the application executing unit transmits the summary information about the additional content to the mobile terminal.

8. The smart TV of claim 7, wherein the summary information about the additional content includes a URL of other broadcasting content associated with the broadcasting content.

9. The smart TV of claim 5, wherein when the sub-content is question content for learning evaluation and when question identification information about question content and answer information about each question are received from the mobile terminal, the application executing unit transmits an evaluation analysis request of a question including the question identification information and the answer information about each question to the educational content server, receives an additional content URL related to identification information about each question from the educational content server, and transmits the additional content URL related to the identification information about each question to the mobile terminal.

10. A method of providing an on-line learning service by using a mobile terminal and a smart television (TV), comprising:
processing and outputting, by the mobile terminal, e-book content including association information indicating association with specific broadcasting content received from an educational content server;
transmitting, by the mobile terminal, a broadcasting content transmission request selected according to a user input signal for selecting broadcasting content associated with e-book content, to the smart TV;
transmitting, by the smart TV, the broadcasting content transmission request of the mobile terminal to a broadcasting content server; and
receiving and outputting, by the smart TV, broadcasting content searched for and acquired by the broadcasting content server by using the association information according to the broadcasting content transmission request.

11. The method of claim 10, further comprising performing, by the smart TV, synchronization with the mobile terminal to provide an on-line learning broadcasting service environment.

12. The method of claim 10, further comprising:
receiving, by the smart TV, an e-book content transmission request for transmission of e-book content from the mobile terminal and transmitting the e-book content transmission request to the educational content server; and
receiving the e-book content from the educational content server and transmitting the received e-book content to the mobile terminal.

13. The method of claim 10, wherein the e-book content includes one or more units of sub-content, and each unit of sub-content includes sub-content association information indicating broadcasting content associated with each unit of sub-content.

14. The method of claim 13, wherein the broadcasting content transmission request selected according to the user input signal for selecting broadcasting content associated with e-book content includes sub-content association information indicating broadcasting content is associated with specific sub-content included in the e-book content, and the sub-content association information includes a broadcasting content URL.

15. The method of claim 13, wherein the sub-content is included in a partial region of a specific page of the e-book, and is text, an image, or an icon that is selectable by a user input signal.

16. The method of claim 10, further comprising:
when receiving summary information about additional content of broadcasting content from the broadcasting content server together with the broadcasting content, transmitting the summary information about the additional content to the mobile terminal by the smart TV; and
outputting the summary information about the additional content by the mobile terminal.

17. The method of claim 16, further comprising:
when the summary information about the additional content includes a URL of other broadcasting content associated with the broadcasting content, and when a user input signal for selecting specific additional content is received from a user of the mobile terminal, transmitting, by the mobile terminal, an additional content request including a URL of the specific additional content to the smart TV; and
transmitting, by the smart TV, the additional content request to the broadcasting content server, and receiving additional content corresponding to the additional content request from the broadcasting content server.

18. The method of claim 13, further comprising:
when the sub-content is question content for learning evaluation and when question identification information about question content and answer information about each question are received from the mobile terminal, transmitting, by the smart TV, an evaluation analysis request of a question including the question identification information and the answer information about each question to the educational content server;
receiving, by the smart TV, additional content URL related to identification information about each question from the educational content server according to the evaluation analysis request; and
transmitting, by the smart TV, the additional content URL related to the identification information about each question to the mobile terminal.
